(19) United States
(12) Patent Application Publication
(10) Pub. No.: US 2013/0268359 A1
(43) Pub. Date: Oct. 10, 2013

(54) SYSTEM, METHOD, AND COMPUTER PROGRAM PRODUCT FOR OFFERING PROMOTIONS BASED ON REAL TIME TRACKING OF CONSUMER ACTIVITIES

(71) Applicant: Kenneth Brian Young, Minneapolis, MN (US)

(72) Inventor: Kenneth Brian Young, Minneapolis, MN (US)

(21) Appl. No.: 13/859,021

(22) Filed: Apr. 9, 2013

Related U.S. Application Data
(60) Provisional application No. 61/622,338, filed on Apr. 10, 2012.

(51) Int. Cl. G06Q 30/02

(52) U.S. Cl. CPC G06Q 30/0255
USPC 705/14.53

(57) ABSTRACT

A server provides a vendor with real time data regarding at least consumer use of network services that are provided to consumer client devices via at least one venue located network access point. At least one indication is received by the server from the vendor, based on the real time data regarding at least consumer use of the network services provided via the at least one venue located network access point, to provide at least one consumer with at least one promotion. In response to the at least one indication, the at least one promotion is transmitted to the at least one customer from the server via the at least one venue located network access point.

### RELATED APPLICATION

The present application claims the benefit under 35 U.S.C. §119(e) to U.S. Provisional Patent Application No. 61/622,338, which was filed on Apr. 10, 2012, and entitled “SYSTEM, METHOD, AND COMPUTER PROGRAM PRODUCT FOR OFFERING PROMOTIONS BASED ON REAL TIME TRACKING OF CONSUMER ACTIVITIES,” which is incorporated by reference as if fully disclosed herein.

### FIELD OF THE INVENTION

This disclosure relates generally to promoting goods and/or services to consumers, and more specifically to systems, methods, and computer program products for offering promotions based on real time tracking of consumer activities.

### BACKGROUND

Venues, such as bars, clubs, sporting and/or other event arenas, casinos, retail stores, and other such locations typically provide goods and/or services that have been obtained from one of more vendors to customers. For example, a nightclub may obtain alcohol from one or more alcohol vendors and may provide alcoholic beverages to customers. In such cases, vendors may obtain information regarding historical consumer activities at a venue or group of venues and may utilize that information to determine one or more promotions to offer in order to increase sales of one or more goods and/or services and/or sales of one or more goods and/or services in general. However, the time delay inherent in obtaining such historical information and transmitting offers for such promotions may limit the usefulness of such techniques as the circumstances and/or consumers at a particular venue likely change over time. The particular circumstances that are reflected in the historical information, and upon which the one or more promotions are based, may have changed to the extent that the one or more promotions no longer reflect the goals of the vendor by the time that they are transmitted.

### SUMMARY

The present disclosure discloses systems, methods, and computer program products for offering promotions based on real time tracking of consumer activities. In a first example implementation, a server may provide a vendor with real time data regarding at least consumer use of network services that are provided to consumer client devices via at least one venue located network access point. At least one indication may be received by the server from the vendor, based on the real time data regarding at least consumer use of the network services provided via the at least one venue located network access point, to provide at least one consumer with at least one promotion. In response to the at least one indication, the server may transmit the at least one promotion to the at least one customer from the server via the at least one venue located network access point.

In a second example implementation, a vendor client device may receive real time data regarding at least consumer use of network services provided via at least one venue located network access point. Based on the real time data, the vendor client device may transmit at least one promotion to the at least one customer via the at least one venue located network access point.

In a third example implementation, a consumer client device may utilize network services provided via at least one venue located network access point. The consumer client device may receive at least one promotion transmitted to the at least one customer client device from the at least one vendor client device via the at least one venue located network access point based on the real time data regarding at least consumer use of the network services provided via the at least one venue located network access point that is provided to the vendor client device.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1 is a block diagram illustrating a system for offering promotions based on real time tracking of consumer activities.

FIG. 2 is a flow chart illustrating a first method for offering promotions based on real time tracking of consumer activities. This method may be performed by the system of FIG. 1.

FIG. 3 is a flow chart illustrating a second method for offering promotions based on real time tracking of consumer activities. This method may be performed by the system of FIG. 1.

FIG. 4 is a flow chart illustrating a third method for offering promotions based on real time tracking of consumer activities. This method may be performed by the system of FIG. 1.

FIG. 5A is a diagram illustrating a display screen that may be displayed on a vendor client device utilizing real time data regarding at least consumer use of the network services at one or more venues. The real time data may provided to the vendor client device by a system such as the system of FIG. 1.

FIG. 5B is a diagram illustrating the display screen of FIG. 5A including explanatory notes.

### DETAILED DESCRIPTION OF THE EMBODIMENTS

The description that follows includes sample systems, methods, and computer program products that embody various elements of the present disclosure. However, it should be understood that the described disclosure may be practiced in a variety of forms in addition to those described herein.

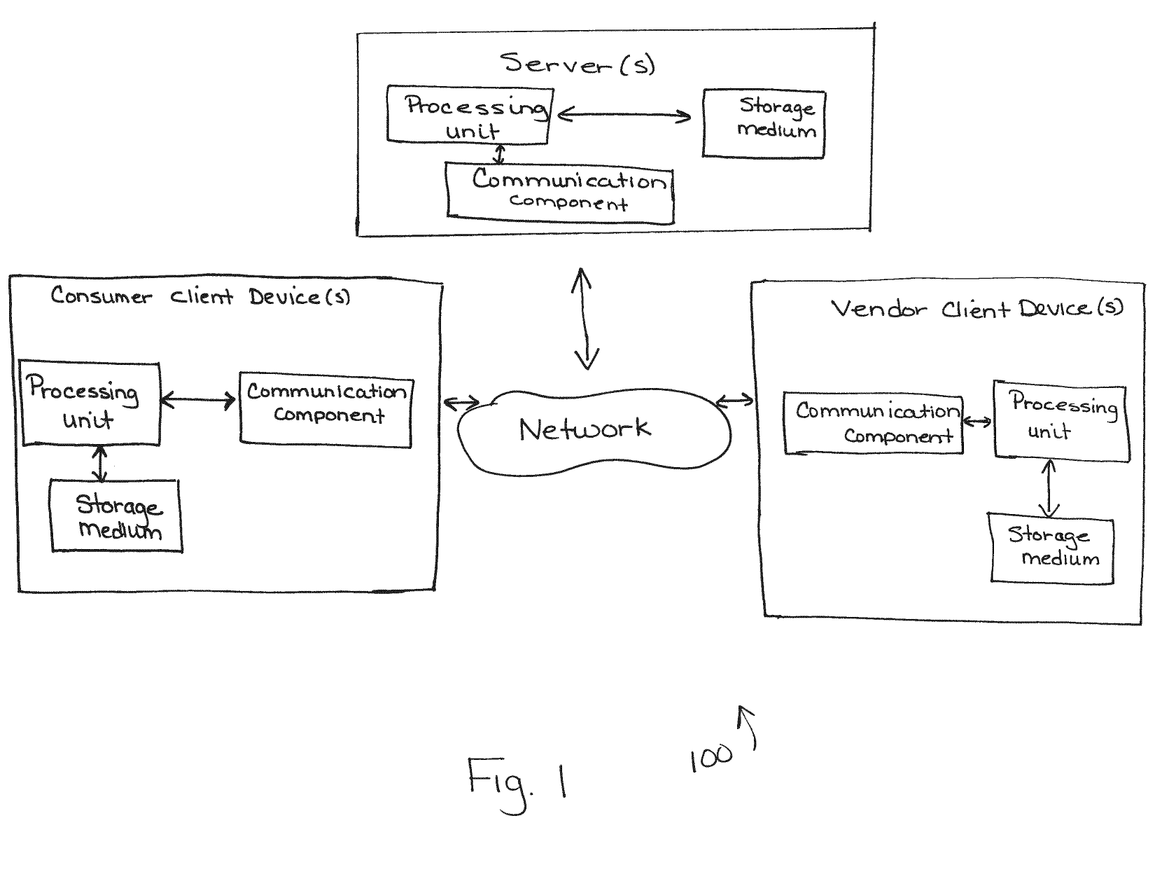

The present disclosure discloses systems, methods, and computer program products for offering promotions based on real time tracking of consumer activities. As illustrated in FIG. 1, in various implementations, one or more servers located at a venue (such as a bar, club, sporting and/or other event arena, casino, retail store, and/or other such location that may provide goods and/or services that have been obtained from one of more vendors to customers) may provide one or more consumer client devices access to one or more network services via one or more wired and/or wireless access points. Real time data regarding consumer use of the network services as well as real time data regarding the venue may be collected by the servers and provided to one or more vendors (such as alcohol distributors and/or any other kind of vendor who provides goods and/or services to the venue for the venue to provide to consumer; in some embodiments, the operator of the venue may also be a vendor in that the operator of the venue provides goods and/or services to the consumers at the venue) via one or more vendor client devices. Based on the real time data, the vendor may transmit one or more promotions to the consumer client devices via the one or more servers.

In some implementations, the server may provide the network services to the client devices by executing software to implement one or more network applications that are related to the venue. Such network applications may include a venue-specific social networking services that consumer client devices located at the venue may utilize, a venue-interaction application that consumer client devices located at the venue may utilize to interact with the venue, other network applications, and/or a combination of these possibilities. The consumer client devices and/or the vendor client devices may interact with such network applications via software executing on the respective device, such as one or more browsers and/or one or more other such viewer and/or interaction applications.

In implementations where the server provides a venue-specific social networking service, users of consumer client devices may utilize the venue-specific social networking service in order to interact with other consumers who are present at the venue. The venue-specific social networking service may allow consumers to obtain information about other consumers who are present at the venue, transmit messages to other consumers present at the venue, discuss aspects of the venue, vote on aspects of the venue, post status updates regarding the consumer's activities at the venue, and/or perform any other electronic-based communication involving other consumers present at the venue.

In some cases, such electronic-based communication may identify the various consumers. However, in other cases, such electronic-based communication may be anonymous and/or utilize various screen names, handles, and/or other methods of specifying particular consumers without revealing the identity of the consumers.

For example, the venue may be a nightclub and the venue-specific social networking service may be a social networking service specific to the consumers present in the nightclub. As such, the nightclub social networking service may allow consumers to obtain information about other consumers who are present at the nightclub, transmit messages to other consumers present at the nightclub (such as messages discussing potential dates, invitations to dance or to have a drink, and/or other such messages), discuss aspects of the nightclub, vote on aspects of the nightclub such as the music currently being played, post status updates regarding the consumer's activities at the nightclub (such as who the consumers is with at the nightclub, whether the consumers is looking for a potential date and/or dance partner, the relationship status of the consumers, what drinks the consumers has ordered, and/or other such information regarding the consumer's activities at the nightclub), and/or perform any other electronic-based communication involving other consumers present at the nightclub.

In implementations where the server provides a venue-interaction application, users of consumer client devices may utilize the venue-interaction application in order to interact with the venue. The venue-interaction application may allow consumers to order goods and/or services from the venue, obtain information regarding goods and/or services available from the venue, utilize an interactive map of the venue, contact the operator of the venue (such as to make one or more complaints regarding the venue), and/or perform any other kind of interaction with the venue.

For example, the venue may be a sporting arena and the venue-interaction application may be a venue-interaction application specific to the sporting arena. As such, the sporting area interaction application may allow consumers to order (as part of which sporting area interaction application may allow consumers to specify the location in the sporting arena where the consumer is located which may be combined with data regarding detection and/or triangulation of the associated consumer client devices by one or more access points) the goods or services from the venue (such as drinks, food, souvenirs, tickets, and/or other such goods and/or services sold by the sporting arena), obtain information regarding goods and/or services available from the sporting arena, obtain information regarding an event going on at the sporting arena (such as team or player statistics, sporting schedules, and/or other such event-related information), utilize an interactive map of the sporting arena, contact the operator of the sporting arena (such as to make one or more complaints regarding the sporting arena), and/or perform any other kind of interaction with the sporting arena.

In cases where the sporting area interaction application may allow consumers to order goods and/or services and/or perform other actions, the server may track whether the consumer and/or the consumer client device has been previously involved in fraudulent and/or otherwise bogus transactions (such as where the consumer ordered goods and then refused to accept and/or pay for the ordered goods) and, if so, may block the consumer from performing such actions.

Regardless of the network services and/or network applications provided by the server, a vendor may utilize a vendor client device to interact with the server to obtain real time data regarding consumer use of the network services and/or network applications as well as real time data regarding the venue. For example, the vendor may access real time data regarding activities that various consumers are performing, messages that one or more consumers are transmitting to one or more other consumers, goods and/or services that one or more consumers are purchasing, and/or any other such real time data regarding consumers and/or the venue.

In some cases, the servers may compile this information from consumers' use of the network services and/or network applications. However, in other cases this information may be supplemented with real time data obtained from one or more venue computer systems, such as one or more point of sale systems. Based on the real time data, the vendor may transmit one or more promotions to one or more of the consumer client devices via the server. Such one or more promotions may be for various goods and/or services that the venue obtains from the vendor and provides to the consumers.

In some implementations the venue may be a bar and/or other liquor-serving establishment. In such an implementation, an alcohol vendor may utilize a vendor client device to interact with the server to obtain real time data regarding consumer use of the network services and/or network applications (such as drink orders, communications that may involve drinking such as a consumer initiating contact with another consumer where a drink may be purchased, and/or other such consumer use) as well as real time data regarding the bar and/or other liquor-serving establishment (such as drinks ordered, which alcohols are being ordered, and/or other such bar and/or other liquor-serving establishment information). Based on this real time data, the vendor may transmit one or more promotions (such as promotions regarding alcohol obtained by the bar and/or other liquor-serving establishment and provided to consumers) to one or more of the consumer client devices via the server. Such promotions may include free and/or discounted drinks, discounts for drinks based on other purchases, drink suggestions, drink recipes, suggestions to buy another consumer a drink, and/or any other such promotion.

A consumer who has received such a promotion may be provided a code to present to the bar and/or other liquor-serving establishment in order to utilize the promotion, an option to order a drink from the bar and/or other liquor-serving establishment utilizing the consumer client device in order to utilize the promotion, and/or any other such means of utilizing the promotion. In some cases, the bar and/or other liquor-serving establishment may obtain information from the customer's use of the promotion, such as one or more promotion identifiers, in order to bill the alcohol vendor for the promotion (such as the cost of the drink where the promotion is for a free drink).

In one example, a vodka vendor may obtain real time data that customers in a bar and/or other liquor-serving establishment are not ordering more than a threshold number of drinks (such as the number of drinks ordered including a competing brand of vodka, the number of drinks ordered including a different type of alcohol, a particular number such as three drinks an hour during a time period defined as “happy hour,” and or other such defined threshold number, which may be defined by the vodka vendor). Based on such real time data, the vodka vendor may transmit one or more vodka-related promotions (such as one or more free drinks involving vodka associated with the vodka vendor, one or more drink recipes that utilize vodka associated with the vodka vendor, and/or other such promotions) to one or more of the consumer client devices via the server.

In another example, a bar and/or other liquor-serving establishment may allow consumers to select, order (whether for a fee or for free), vote on, download to the consumer client device, or perform other actions related to music that is played within the bar and/or other liquor-serving establishment. In some implementations, the consumers may be allowed to perform such actions by interacting with provided network services and/or network applications via consumer client devices. In this example, a music vendor (such as a music artist, a music label, and/or any other kind of music vendor) may obtain real time data that customers in the bar and/or other liquor-serving establishment are not selecting and/or ordering music associated with the music vendor to be played by the bar and/or other liquor-serving establishment over a particular threshold. Based on such real time data, the music vendor may transmit one or more music-related promotions (such as one or more free drinks courtesy of music associated with the music vendor, contact between the customer and the music artist associated with the music, discounted drinks upon selection or order of music associated with the music vendor, a free or discounted downloadable song from the music vendor, and so forth) to one or more of the consumer client devices via the server.

In providing network services and/or network applications, the server may track individual consumers and/or individual consumer client devices. For example, the server may track a unique identifier associated with consumer client devices (such as media access control addresses associated with consumer client devices), allow consumers to log into individual consumer accounts for the network services and/or network applications, allow consumers to log into the network services and/or network applications utilizing credentials from an unassociated social networking service, and/or a combination of these options.

In one case, the server may identify individual consumers solely by a unique identifier associated with consumer client devices. In another case, the server may enable a consumer to log into the network services and/or network applications and create an account that the consumer will be tracked by. In still another case, the server may enable a consumer to log into the server in order to utilize network services and/or network applications and create an account that is associated with the a unique identifier associated with the consumer's consumer client device such that the consumer's account will be later recognized based on detection of the unique identifier rather than requiring the consumer to log in every time the user visits one or more venues.

In various implementations, when a vendor may utilize a vendor client device to interact with the server to obtain real time data regarding consumer use of the network services and/or network applications as well as real time data regarding the venue, the vendor may be provided with a variety of different customizable views of such real time data. Such a customizable view may enable a vendor to select whether to present real time data from a venue and/or more than one venue (in which case, the vendor may be able to select whether the real time data from the respective venues are combined in a single display, presented in separate displays, and/or a combination of the two).

If information about consumers is included in the real time data (such as information entered by consumers as part of a registration process, information deduced from consumer usage, information obtained from a separate social networking service that consumers utilize to log into the network services and/or network applications provided by the server, and/or other such means of determining information about users), the vendor may be able to select which consumers to display real time data for and/or how such real time data is presented. The information may includes names, screen names, data regarding participation in one or more reward systems, email and/or other address and/or telephone information, residence information such as address and/or zip code, age, the venue and/or portion of a venue where a consumer is located (such as identifying that a consumer is in a sky box at a baseball stadium as opposed to a bleacher section based on a particular network access point that the consumer is connected to as opposed to other available access points), whether or not the consumer is currently connected and/or utilizing to the network services and/or network application, goods and/or services the consumer has purchased during their current visit to the venue and/or previous visits, and other such information regarding consumers.

The customizable views may also present overall venue real time data regarding one or more goods and/or services that the venue provides to customers on behalf of the vendor and/or competing goods and/or services, such as the number of servings ordered of various different alcohols organized according to type of alcohol. Additionally, the customizable views may present real time data regarding consumer utilization of offered promotions. Such real time data regarding consumer utilization of offered promotions may provide real time data regarding compensation currently owed by the vendor to the venue for honoring the promotions.

In addition to providing various customizable views of the real time data, the vendor client device may enable the vendor to interact with the server to transmit one or more promotions to one or more of the consumers via the server based on the real time data. As the real time data regarding various consumers, venues, and such may be selected and ordered according to any categorization and/or criteria of the real time data, the vendor may also be able to utilize the vendor client device to select consumers based on any such categorization and/or criteria and transmit promotions to such selected consumers.

For example, a liquor vendor may be able to select only female consumers at a bar and transmit discounted drink promotions to such selected female consumers. By way of another example, a hot dog vendor may be able to select only consumers located in skyboxes at a baseball stadium and transmit promotions for free drinks with the purchase of a hot dog to such skybox located consumers. By way of a third example, a soft drink vendor may be able to select consumers at a nightclub who have not ordered any alcoholic beverages and transmit promotions for designated driver discounted soft drinks to such nightclub consumers who have not ordered any alcoholic beverages.

In addition to vendors being able to utilize vendor client devices to access the real time data and/or transmit offers in real time based on the real time data, vendors may utilize the vendor client devices to enter one or more rules which may automatically transmit one or more promotions whenever the real time data satisfies one or more of the rules. Such rules may be stored at and/or evaluated according to the real time data by vendor client devices, the server, and/or a combination thereof. For example, a liquor vendor may enter a rule to transmit promotions for discounted drinks to customers whenever more than a threshold amount of a particular liquor has not been purchased at a venue within a particular time period, such as twenty servings of that particular liquor within a one hour time frame.

In various implementations, the consumer client devices may execute a browser application in order to access the network services and/or network applications. Such a browser may handle all communications to and/or from the server and/or the vendor client device. For example, promotions transmitted by the vendor client device may be stored for a consumer in a queue implemented in a storage medium of the server for the consumer such that the browser retrieves the promotions from the queue and presents them to the consumer. As such, the consumer may not be required to pay mobile service charges associated with mobile network communication (such as per text message charges for communications received and/or transmitted via text message) if the consumer client device is a mobile device such as a smart phone.

In one or more implementations, one or more of the servers may be located in one or more locations other than the venue. In such cases, the one or more network access points may be located at the venue and the one or more servers located elsewhere may communicate with the venue located network access points in order to provide network services and/or network applications to consumer client devices. In some cases, such servers may communicate with one or more servers that are located at the venue in order to communicate with the network access points.

The server may provide consumer client devices access to one or more network services via various different kinds of wired and/or wireless access points. For example, in one implementation, consumer client devices may include a variety of different mobile computing devices (such as one or more smart phones and/or other cellular phones, laptop computers, mobile computers, tablet computers, and so on) that are operable to communicate wirelessly (such as via WiFi, Bluetooth, BLE (Bluetooth low energy), and/or other such wireless technology) and are brought to the venue by the consumers and the access points may include one or more wireless access points (such as one or more WiFi, Bluetooth, BLE and/or other such wireless technology routers and/or other access devices) that provide the consumer client devices wireless access (such as via WiFi, Bluetooth, BLE (Bluetooth low energy), and/or other such wireless technology) to the server. In another implementation, consumer client devices may include one or more wired terminals provided by the venue to consumers that the consumers may utilize to access the servers via one or more wired connection to an access point (such as router and/or other device) via one or more wired access points such as one or more Ethernet jacks. In still another implementation, consumer client devices may include venue-provided wireless terminals (such as portable terminals utilized to access a network trivia game) that provide wireless access (such as via WiFi, Bluetooth, BLE (Bluetooth low energy), and/or other such wireless technology) to the server.

The consumer client devices, servers, and/or vendor client devices may each include one or more processing units, one or more wired and/or wireless communication components (such as WiFi, Bluetooth, BLE (Bluetooth low energy), and/or other such wireless technology communication components), and one or more non-transitory storage media (which may take the form of, but is not limited to, a magnetic storage medium; optical storage medium; magneto-optical storage medium; read only memory; random access memory; erasable programmable memory; flash memory; and so on). The consumer client devices, servers, and/or vendor client devices may each perform a variety of different functions by the one or more processing units executing software stored in the one or more non-transitory storage media.

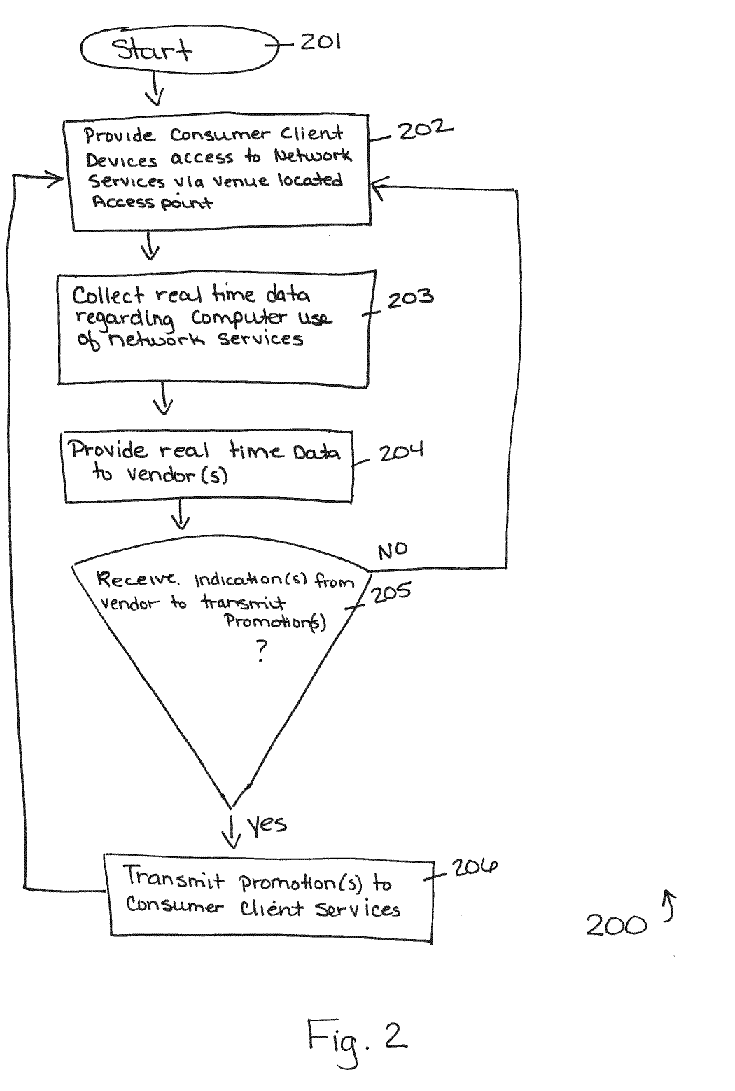

FIG. 2 illustrates a first method 200 for offering promotions based on real time tracking of consumer activities. The method 200 may be performed by the server of FIG. 1. The flow begins at block 201 and proceeds to block 202 where the server provides consumer client devices access to one or more network services and/or network applications via one or more venue located network access points. The flow then proceeds to block 203 where the server collects real time data regarding at least consumer use of the network services and/or network applications. The flow then proceeds to block 204 where the server provides the real time data to one or more vendors before the flow proceeds to block 205. In some embodiments, the vendor may be the operator of the venue.

At block 205, the server determines whether or not one or more indications are received from the one or more vendors to transmit one or more promotions to one or more consumers based on the provided real time data. If so, the flow proceeds to block 206. Otherwise, the flow returns to block 202 where the server continues to provide consumer client devices access to the one or more network services and/or network applications via the one or more venue located network access points.

At block 206, after the server determines that one or more indications are received from the one or more vendors to transmit one or more promotions to one or more consumers based on the provided real time data, the server transmits the one or more promotions to one or more consumer client devices associated with the one or more consumers. The flow then returns to block 202 where the server continues to provide consumer client devices access to the one or more network services and/or network applications via the one or more venue located network access points.

Although the method 200 is illustrated and described as including a particular series of operations performed in a particular order, it is understood that other arrangements of different series of operations are contemplated and possible without departing from the scope of the present disclosure. For example, operations 202-205 are illustrated as a series of linear, sequential steps. However, in various implementations such operations may be performed in different orders and/or one or more of the operations may be performed simultaneously and/or substantially simultaneously.

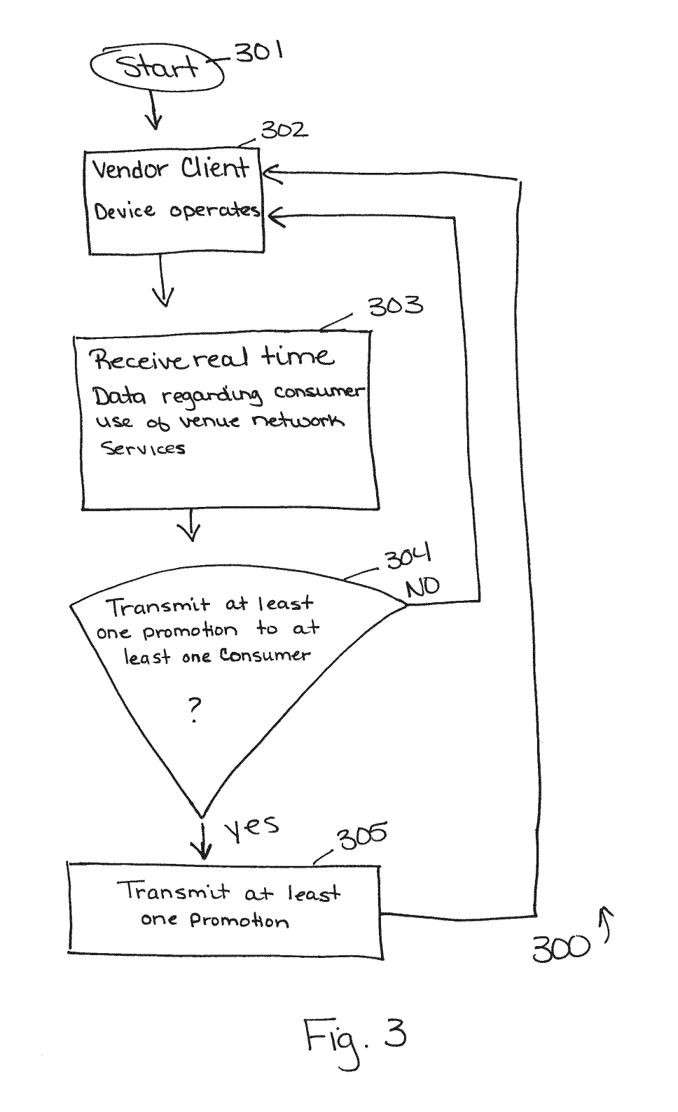

FIG. 3 illustrates a second method 300 for offering promotions based on real time tracking of consumer activities. The method 300 may be performed by the vendor client device of FIG. 1. The flow begins at block 301 and proceeds to block 302 where the vendor client device operates. The flow then proceeds to block 303 where the vendor client device receives real time data regarding at least consumer use of network services and/or network applications provided by at least one server via at least one venue located network access point.

The flow then proceeds to block 304 where the vendor client device determines whether or not to transmit at least one promotion to at least one consumer based on the real time data. If so, the flow proceeds to block 305. Otherwise, the flow returns to block 302 where the vendor client device continues to operate. In some cases, such a determination may be based on input received from an operator of the vendor client device. In other cases, such a determination may be automatically performed one or more rules configured by an operator of the vendor client device.

At block 305, after the vendor client device determines to transmit at least one promotion to at least one consumer based on the real time data, the vendor client device transmits the at least one promotion to at least one consumer client device associated with the at least one consumer via the at least one venue located network access point. The flow then returns to block 302 where the vendor client device continues to operate.

Although the method 300 is illustrated and described as including a particular series of operations performed in a particular order, it is understood that other arrangements of different series of operations are contemplated and possible without departing from the scope of the present disclosure. For example, operations 303-304 are illustrated as a series of linear, sequential steps. However, in various implementations such operations may be performed in different orders and/or the operations may be performed simultaneously and/or substantially simultaneously.

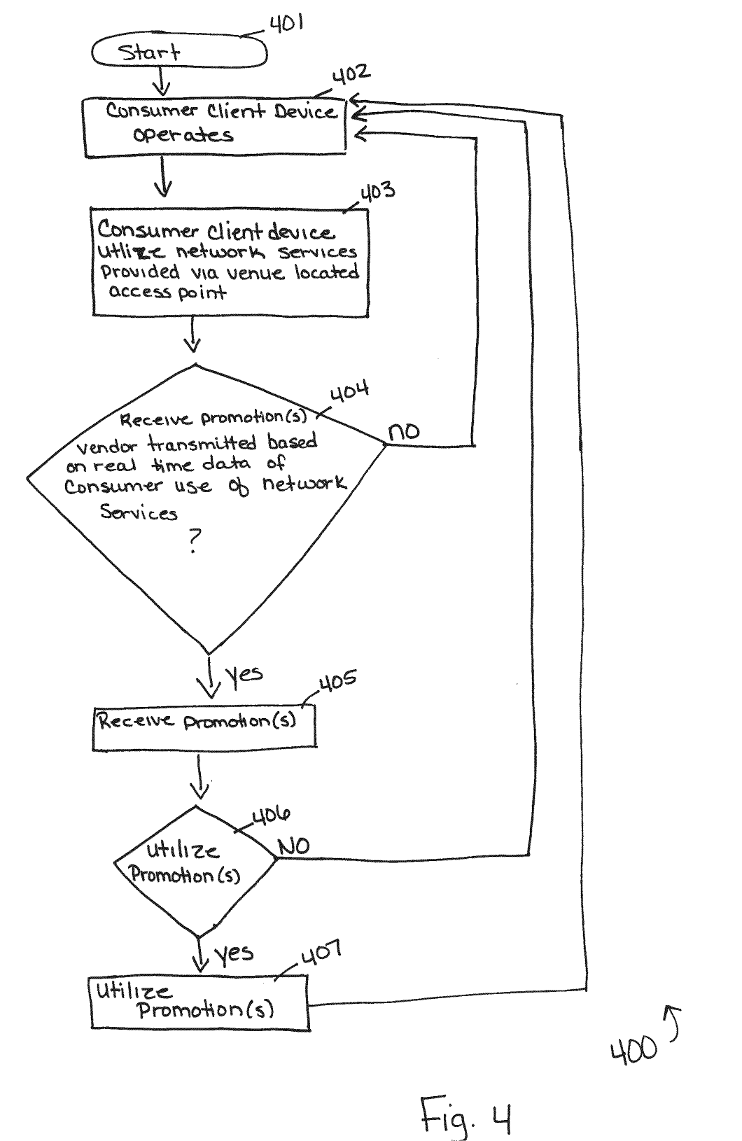

FIG. 4 illustrates a method 400 for offering promotions based on real time tracking of consumer activities. The method 400 may be performed by the consumer client device of FIG. 1. The flow begins at block 401 and proceeds to block 402 where the consumer client device operates. The flow then proceeds to block 403 where the consumer client device utilizes network services and/or network applications provided by at least one server via at least one venue located network access point.

The flow then proceeds to block 404 where the consumer client device determines whether or not one or more promotions are received that have been transmitted by one or more vendors based on real time data regarding at least consumer use of network services and/or network applications provided by at least one server via at least one venue located network access point. If so, the flow proceeds to block 405. Otherwise, the flow returns to block 402 where the consumer client device continues to operate.

At block 405, after the consumer client device determines that one or more promotions are received that have been transmitted by one or more vendors based on real time data regarding at least consumer use of network services and/or network applications provided by at least one server via at least one venue located network access point, the one or more promotions are received by the consumer client device and the flow proceeds to block 406.

At block 406, the consumer client device determines whether or not to utilize the one or more promotions. If so, the flow proceeds to block 407. Otherwise, the flow the flow returns to block 402 where the consumer client device continues to operate. In some cases, such a determination may be based on input received by the consumer client device from the consumer.

At block 407, after the consumer client device determines to utilize the one or more promotions, the consumer client device utilizes the one or more promotions. The flow then returns to block 402 where the consumer client device continues to operate.

Although the method 400 is illustrated and described as including a particular series of operations performed in a particular order, it is understood that other arrangements of different series of operations are contemplated and possible without departing from the scope of the present disclosure. For example, operations 403-404 are illustrated as a series of linear, sequential steps. However, in various implementations such operations may be performed in different orders and/or the operations may be performed simultaneously and/or substantially simultaneously.

A specific implementation of the present disclosure will now be described. Consumers may utilize mobile computing devices such as mobile phones, tablet computing devices, and other such mobile computing devices to execute a browser application when located at a bar. The consumers may use the browser application to utilize a bar specific social network provided by a server (which may and/or may not be actually located at the bar) via one or more bar located WiFi routers. The bar specific social network may enable bar patrons to communicate with each other as well as order drinks and/or other items provided by the bar.

The server may monitor consumer's use of the bar specific social network, as well as perform bar specific social network functions in response to user instructions, and collect real time data regarding such usage. The server may store a separate message queue for each consumer that stores any messages to and/or from the consumer and the browser application may manage communications by interacting with the appropriate server queue. The server may make the collected real time data, possibly along with other real time data collected by other bar systems, to one or more vendors.

A liquor vendor may utilize a vendor client device to execute a browser application in order to interact with the server. The server may store the collected real time data and provide such real time data to the browser application executing on the vendor client device. The browser application executing on the vendor client device may enable the vendor to select the information the liquor vendor wishes to view (real time data from which bars, concerning which categories of consumers, concerning which products, and/or any other such information) and/or how that information is presented (organized on a per venue basis, per consumer basis, per selected category of user basis, and other such organization of information). The browser application executing on the vendor client device may present the liquor vendor with real time data regarding what drinks consumers have purchased, overall statistics regarding liquor purchases over periods of time, and/or any other such real time data.

Based on the presented real time data, the liquor vendor may utilize the browser application to instruct the server to transmit one or more promotions to one or more of the consumers via one or more consumer client devices. For example, if vodka sales are below what the liquor vendor wants, the liquor vendor may utilize the browser application to instruct the server to transmit one or more vodka promotions in order to stimulate consumer purchasing of vodka at the bar.

The server, based on the instructions received from the browser application executing on the vendor client device, may place one or more promotions in the respective queues on the server for one or more of the consumers. Then, the browser applications executing on the respective consumer client devices associated with the respective consumers may retrieve the promotions from the respective queues and present them to the respective consumers. Consumers who receive such promotions may use the respective browser applications to utilize the promotions. Based on utilization of the promotions, the server and/or the bar may track compensation that the liquor vendor may owe for promotion utilization and may bill the liquor vendor accordingly.

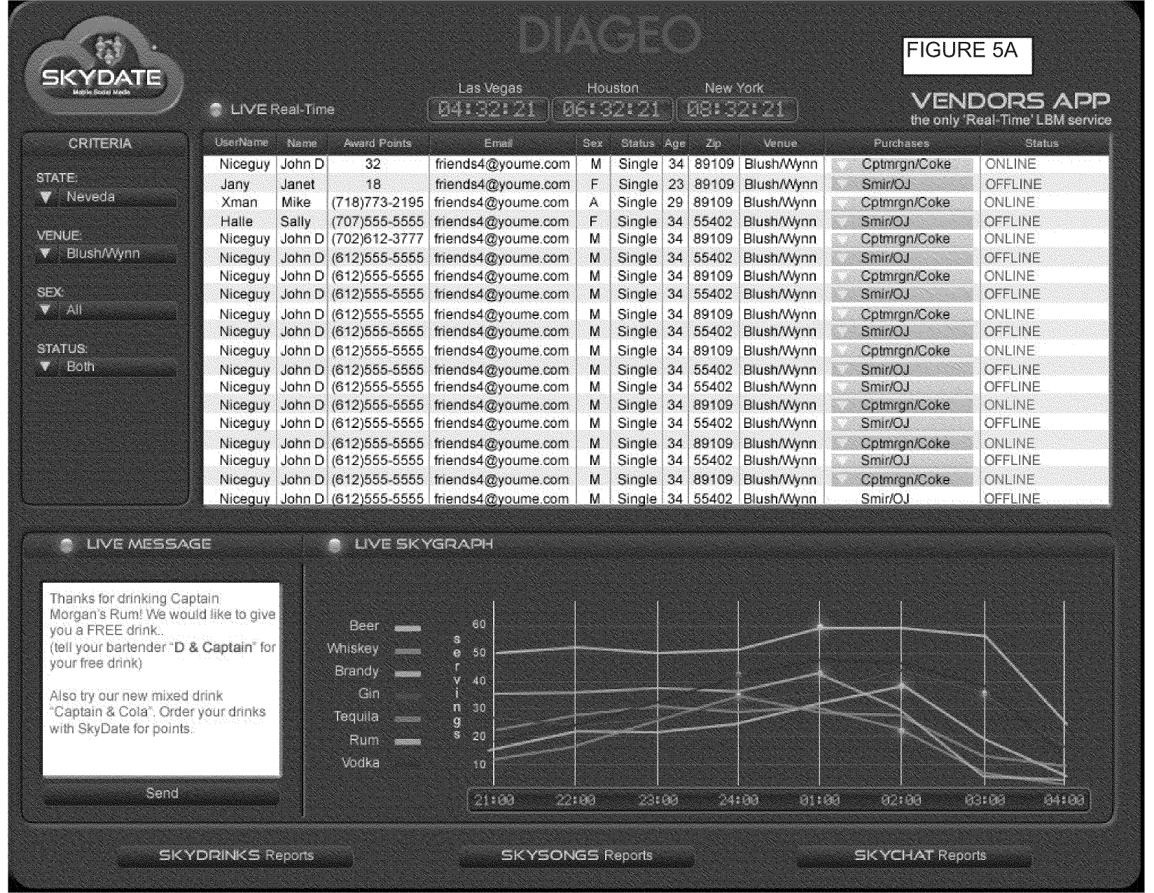

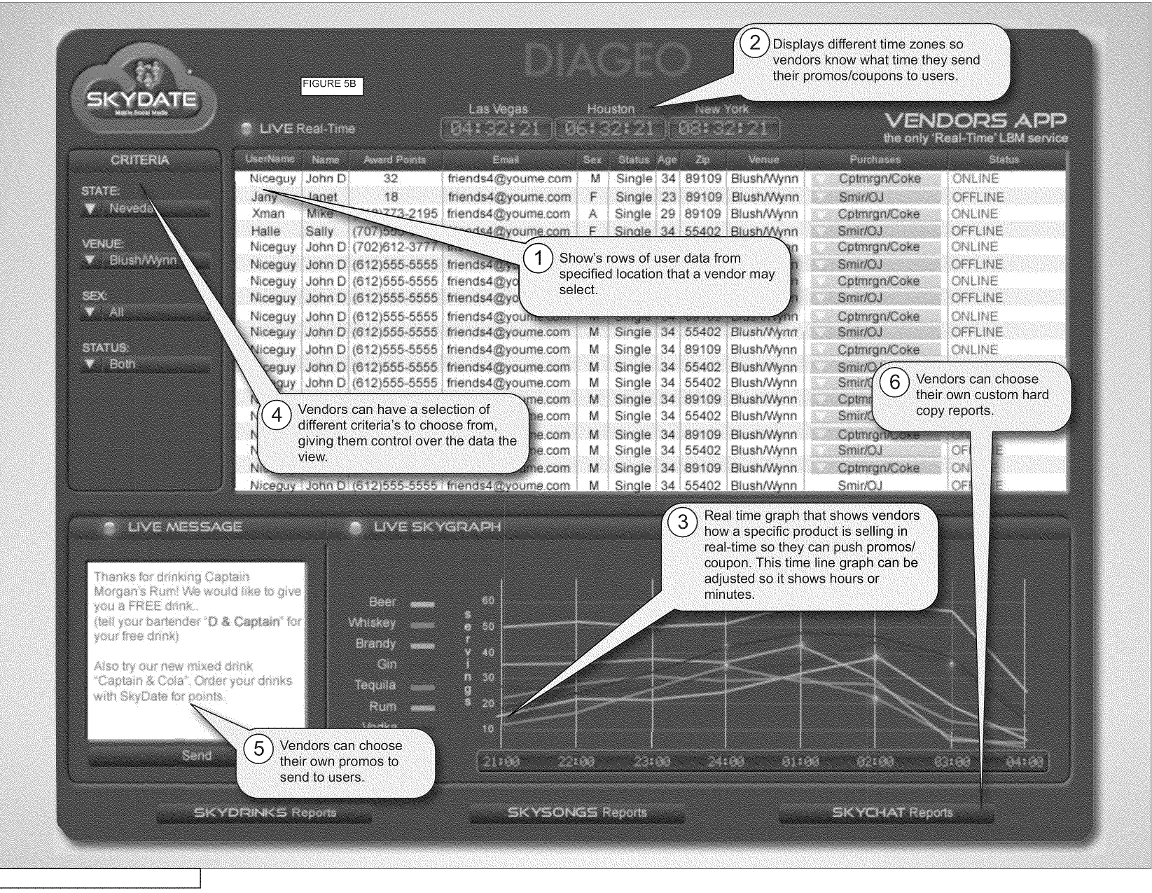

5A is a diagram illustrating an example browser display screen that may be displayed on a vendor client device utilizing real time data regarding at least consumer use of the network services at one or more venues. The real time data may provided to the vendor client device by a system such as the system of FIG. 1. FIG. 5B is a diagram illustrating the example browser display screen of FIG. 5A including explanatory notes.

As illustrated in FIGS. 5A and 5B, the example browser display screen may include a variety of user information from a specified location that may be organized by user and/or category. Such information may include user name, actual name, award points if the user is part of a reward program, user email, user gender, user relationship status, user age, user zip code, the venue that the user is present at, purchases that the user has made, and/or the status of whether or not the user is currently interacting with the server. As also illustrated, the example browser display screen may also display different time zones that may be related to the different venues selected.

As further illustrated in FIGS. 5A and 5B, the example browser display screen may include a real time product data graph related to product sales at the selected venue, criteria selection elements that a vendor can utilize to customize the real time data for which locations the example browser display screen will show, promotion transmittal elements that allow vendors to enter which promotions to transmit to consumers, and selection elements for generating various real time data, vendor-related, consumer-related, and/or venue related reports.

It is understood that the example browser display screen illustrated in FIGS. 5A and 5B and described above is for the purposes of example. The present disclosure is not limited to the example browser display screen illustrated in FIGS. 5A and 5B and described above.

Although the present disclosure is illustrated and described above in the context of a venue, it is understood that this is for the purposes of example and the techniques of the present disclosure may be applied in a variety of contexts without departing from the scope of the present disclosure. In various implementations, the techniques illustrated and described herein may be applied in various contexts, such as stores, department stores, malls, stadiums, arenas, shops, and/or any other such location(s).

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

1. A method for offering promotions based on real time tracking of consumer activities, the method comprising:
providing a vendor with real time data regarding at least consumer use of network services provided via at least one venue located network access point;
receiving at least one indication to provide at least one consumer with at least one promotion based on the real time data regarding at least consumer use of the network services provided via the at least one venue located network access point; and
transmitting the at least one promotion to the at least one customer via the at least one venue located network access point.

2. The method of claim 1, wherein the network services comprise a venue-specific social networking service.

3. The method of claim 1, wherein the network services comprise a venue-interactive application that allows at least one consumer to interact with at least one venue where the at least one venue located access point is located.

4. The method of claim 1, wherein the network services are provided by at least one network server located in a location other than the at least one venue where the at least one venue located access point is located and wherein the at least one network server is communicably connected to the at least one venue located access point.

5. The method of claim 1, wherein the at least one promotion includes at least one identifier that the at least one customer can present to at least one venue in order to utilize the at least one promotion.

6. The method of claim 1, wherein the at least one customer can utilize the at least one promotion utilizing at least one consumer client device that receives the at least one promotion from the at least one venue located network access point.

7. The method of claim 1, wherein the at least one promotion includes at least one identifier that at least one venue can utilize to claim reimbursement for the at least one promotion from the vendor.

8. The method of claim 1, wherein the at least one customer accesses the network services provided via the at least one venue located network access point utilizing at least one browser application executed by at least one client device.

9. The method of claim 1, wherein said operation of receiving at least one indication to provide at least one consumer with at least one promotion based on the real time data regarding at least consumer use of the network services provided via the at least one venue located network access point further comprises determining the real time data satisfies at least one rule specified by the vendor.

10. The method of claim 1, wherein the at least one venue located network access point comprises at least one wireless network router.

11. The method of claim 1, wherein said operation of providing a vendor with real time data regarding at least consumer use of network services provided via at least one venue located network access point further comprises providing the vendor with real time data regarding at least consumer use of network services provided via a plurality of venue located network access points wherein at least two of the plurality of venue located network access points are located at different venues.

12. A system for offering promotions based on real time tracking of consumer activities, comprising:
at least one venue located network access point; and
at least one server, communicably coupled to the at least one venue located network access point, wherein the at least one server provides network services via at least one venue located network access point to at least one consumer client device;
wherein the at least one server provides a vendor with real time data regarding at least consumer use of the network services provided via the at least one venue located network access point, receives at least one indication to provide at least one consumer with at least one promotion based on the real time data regarding at least consumer use of the network services, and transmits the at least one promotion to the at least one customer via the at least one venue located network access point.

13. The system of claim 12, wherein the at least one server is located in a location other than at least one venue where the at least one venue located access point is located.

14. The system of claim 12, wherein the at least one promotion includes at least one identifier that the at least one customer can present to at least one venue in order to utilize the at least one promotion.

15. The system of claim 12, wherein the at least one customer can utilize the at least one promotion utilizing at least one consumer client device that receives the at least one promotion from the at least one venue located network access point.

16. The system of claim 12, wherein the at least one promotion includes at least one identifier that at least one venue can utilize to claim reimbursement for the at least one promotion from the vendor.

17. The system of claim 12, wherein the at least one customer accesses the network services provided via the at least one venue located network access point utilizing at least one browser application executed by at least one client device.

18. The system of claim 12, wherein the at least one venue located network access point comprises at least one wireless network router.

19. The system of claim 12, wherein the at least one venue located network access point comprises a plurality of venue located network access points wherein at least two of the plurality of venue located network access points are located at different venues.

20. A computer program product comprising:
a first set of instructions, stored in at least one non-transitory machine readable medium, executable by at least one processing unit to provide a vendor with real time data regarding at least consumer use of network services provided via at least one venue located network access point;
a second set of instructions, stored in the at least one non-transitory machine readable medium, executable by the at least one processing unit to receive at least one indication to provide at least one consumer with at least one promotion based on the real time data regarding at least consumer use of the network services provided via the at least one venue located network access point; and
a third set of instructions, stored in the at least one non-transitory machine readable medium, executable by the at least one processing unit to transmit the at least one promotion to the at least one customer via the at least one venue located network access point.
